(19) United States
(12) Patent Application Publication
(10) Pub. No.: US 2011/0257318 A1
(43) Pub. Date: Oct. 20, 2011

(54) CLEAR SYNTHETIC BINDER

(75) Inventors: Matthieu Neuville, Irigny (FR); Sylvie Zucco, La Garenne Colombes (FR); Danièle Barion, Les Roches De Condrieu (FR)

(73) Assignee: TOTAL RAFFINAGE MARKETING, PUTEAUX (FR)

(21) Appl. No.: 13/128,318

(22) PCT Filed: Nov. 13, 2009
(86) PCT No.: PCT/IB09/55061

§ 371 Date: Jul. 12, 2011

(30) Foreign Application Priority Data
Nov. 14, 2008 (FR) 08/06354
May 7, 2009 (FR) 09/02237

(51) Int. Cl. C08K 5/09

(52) U.S. Cl. 524/322

(57) ABSTRACT

The disclosure relates to a clear synthetic binder comprising at least one oil of plant origin, at least one resin of petroleum origin and at least one polymer, the amount of oil of plant origin in the binder is greater than or equal to 10% by weight and the amount of polymer in the binder is less than or equal to 15% by weight. The clear synthetic binder according to the disclosure has a good consistency, a reduced viscosity, and suitable behaviour at low temperature and elastic properties. The disclosure also relates to a bituminous mix prepared from said clear synthetic binder, this bituminous mix is prepared at temperatures between 100° C. and 160° C., preferably between 120° C. and 140° C. and has suitable rutting resistance and water resistance.

### CROSS-REFERENCE TO RELATED APPLICATIONS

This application is a National Phase Entry of International Application No. PCT/IB2009/055061, filed on Nov. 13, 2009, which claims priority to French Patent Application Serial No. 09 02237, filed on May 7, 2009, which claims priority to French Patent Application Serial No. 08 06 354, filed on Nov. 14, 2008, all of which are incorporated by reference herein.

### TECHNICAL FIELD

The present invention concerns a clear synthetic binder which can substitute for conventional black bituminous binders in some roadway and/or industrial applications.

### BACKGROUND

Conventional bituminous binders, owing to the presence of asphaltenes, are of black colour and are therefore difficult to colour. Coloured surfaces are being given increasing use since inter alia they can help improve road-user safety by clearly identifying specific lanes such as footpaths, cycle lanes, bus lanes. They can also be used to mark out some hazard areas such as entries into town centres or dangerous bends. Coloured surfaces promote visibility under low light conditions, for example at night or for particular sites such as tunnels. Finally, they quite simply allow an improvement in the attractiveness of urban road systems and can be used for public squares, building and school courtyards, pavements, footpaths, alleyways in parks and gardens, parking and rest areas. Therefore, for all the above-cited applications it is preferred to use clear synthetic binders which do not contain asphaltenes and are able to be coloured.

### TECHNICAL PROBLEM

Most prior art clear synthetic binders are formulated from resins of petroleum origin and oils of petroleum origin. These clear synthetic binders are therefore entirely of petroleum origin. For example, in European patent EP179510 the clear synthetic binders are prepared with a mixture of an extract of mineral lubricant oil and a modified resin. These resins are chosen among resins of petroleum origin and coumarone-indene resins of fossil origin. Provision may be made for the addition of a synthetic rubber to the clear synthetic binders.

Similarly, patent EP0330281 describes a pigmentable binder composition comprising a mineral lubricating oil derivative, a resin of modified hydrocarbon type and an amorphous homopolymer or copolymer of an alpha-olefin. These clear binders entirely of petroleum origin are therefore formulated from non-renewable raw materials, and it is therefore desirable to find substitution products for these non-renewable raw materials and hence desirable to formulate clear synthetic binders from renewable raw materials.

### SUMMARY

In this perspective, the applicant company has sought to replace part of the constituents of clear synthetic binders of petroleum origin by renewable constituents of plant origin. The applicant company has unexpectedly established that the substitution of an oil of petroleum origin by an oil of vegetable origin in a clear synthetic binder allows a clear synthetic binder to be obtained having equivalent or better physical and mechanical properties than those of a clear synthetic binder entirely of petroleum origin. For this purpose, the invention proposes a clear synthetic binder comprising at least one oil of plant origin, at least one resin of petroleum origin and at least one polymer, the quantity of oil of plant origin in the binder is equal to or more than 10 weight % and the quantity of polymer in the binder is equal to or less than 15 weight %.

### OBJECTIVES

One of the objectives of the present invention is therefore to propose a clear synthetic binder partly formulated from renewable raw materials and in particular from an oil of plant origin. Another objective of the present invention is therefore to propose a clear synthetic binder, formulated partly from renewable raw materials, which has chemical, physical and mechanical properties that are equivalent to or an improvement on a clear synthetic binder formulated entirely from raw materials of petroleum origin.

In particular, one of the objectives of the present invention is to propose a clear synthetic binder partly formulated from renewable raw materials having a consistency (penetration value, Ball and Ring temperature) adapted to different applications. In particular, one of the objectives of the present invention is to propose a clear synthetic binder, partly formulated from renewable raw materials, having moderate warm viscosity thereby allowing a reduction in the temperatures needed for production, laying and compacting when manufacturing mixes and asphalts from said clear synthetic binder, thereby allowing energy savings and a reduction in smoke emissions during such manufacture. In particular, one of the objectives of the present invention is to propose a clear synthetic binder partly formulated from renewable raw materials which is stable when stored.

In particular, one of the objectives of the present invention is to propose a clear synthetic binder partly formulated from renewable raw materials which withstands ageing. In particular, one of the objectives of the present invention is to propose a clear synthetic binder partly formulated from renewable raw materials having good resistance to cold. In particular, one of the objectives of the present invention is to propose a clear synthetic binder partly formulated from renewable raw materials having good elastic properties.

In particular, one of the objectives of the present invention is to propose a clear synthetic binder partly formulated from renewable raw materials whose colour is stable. In particular, one of the objectives of the present invention is to propose a mix formulated from a clear synthetic binder which is waterproof. In particular one of the objectives of the present invention is to propose a mix formulated from a clear synthetic binder having resistance to rutting adapted to the type of chosen application.

These objectives and others are achieved with the formulation of a clear synthetic binder comprising at least one oil of plant origin, at least one resin of petroleum origin and at least one polymer, the quantity of oil of plant origin in the binder is equal to or more than 10 weight %, and the quantity of polymer in the binder is equal to or less than 15 weight %.

### BRIEF DESCRIPTION

The invention concerns a clear synthetic binder comprising at least one oil of plant origin, at least one resin of petroleum origin and at least one polymer, the quantity of oil of plant origin in the binder being equal to or more than 10 weight %, and the quantity of polymer in the binder being equal to or less than 15 weight %. Preferably the quantity of oil of plant origin in the binder lies between 10 and 70 weight %, preferably between 20 and 60%, more preferably between 30 and 50% and further preferably between 10 and 50%. Preferably, the clear synthetic binder is free of oil of petroleum origin.

Preferably, the quantity of polymer in the binder lies between 1 and 15 weight %, preferably between 2 and 10%, more preferably between 3 and 5%. Preferably, the quantity of resin of petroleum origin in the binder lies between 15 and 75 weight %, preferably between 30 and 70%, more preferably between 40 and 60%. Preferably the ratio between the weight quantities of oil or plant origin and the resin of petroleum origin lies between 0.3 and 2, preferably between 0.5 and 1. Preferably, the oil of plant origin is chosen from among canola, sunflower, soybean, flax, olive, palm, castor, wood, corn, pumpkin seed, grape seed, jojoba, sesame, walnut, hazelnut, almond, shea, macadamia, cotton, alfalfa, rye, safflower, groundnut, coconut and copra oils, and mixtures thereof. Preferably, the resin is chosen from among resins of hydrocarbon petroleum origin derived from the copolymerisation of aromatic, aliphatic or cyclopentadiene petroleum fractions taken alone or in a mixture, preferably derived from the copolymerisation of aromatic petroleum fractions. Preferably, the resin is resin derived from the copolymerisation of styrene monomers and indene monomers. Preferably, the resin has a softening point of between 90° C. and 220° C., preferably between 110° C. and 200° C., more preferably between 130° C. and 180° C. and further preferably between 150° C. and 160° C.

Preferably, the polymer is chosen from among the copolymers of styrene and butadiene, the copolymers of styrene and isoprene, the ethylene/propene/diene terpolymers, polychloroprenes, the copolymers of ethylene and vinyl acetate, the copolymers of ethylene and methyl acrylate, the copolymers of ethylene and butyl acrylate, the ethylene/methyl acrylate/glycidyl methacrylate terpolymers, the ethylene/butyl acrylate/maleic anhydride terpolymers, the atactic polypropylenes, taken alone or in mixtures, preferably from among the copolymers of styrene and butadiene and the copolymers of ethylene and vinyl acetate taken alone or in mixtures. Preferably, the ratio between the weight quantities of styrene and butadiene copolymers and ethylene and vinyl acetate copolymers lies between 0.25 and 2, preferably between 0.5 and 1. Preferably, in one first embodiment, the oil of plant origin comprises 10 to 90 weight % of free fatty acids relative to the weight of oil of plant origin. Preferably, in a second embodiment the oil of plant origin comprises 0.1 to 5 weight % of free fatty acids relative to the weight of oil of plant origin.

The invention also concerns a method for preparing a clear synthetic binder such as defined above comprising the following steps:

(i) mixing and heating the oil of plant origin to a temperature of between 140° C. and 200° C.,

(ii) gradually adding the resin of petroleum origin, mixing and heating to a temperature of between 140° C. and 200° C.,

(iii) adding the polymer(s), mixing and heating to a temperature of between 140° C. and 200° C.,

(iv) optionally adding an adhesion agent, mixing and heating to a temperature of between 140° C. and 200° C.

The invention also concerns a mix comprising a clear synthetic binder such as defined above and aggregates, optionally fillers and optionally pigments. The invention also concerns a method for preparing a mix such as defined above comprising the mixing of a clear synthetic binder such as defined above with aggregates, optionally fillers and optionally pigments, wherein the coating temperature lies between 100° C. and 160° C. preferably between 120° C. and 140° C. The invention also concerns an emulsion of clear synthetic binder, comprising a clear synthetic binder such as defined above, water and an emulsifying agent.

The invention also concerns a method for preparing an emulsion of clear synthetic binder such as defined above, comprising the dispersion of the synthetic binder such as defined above in an emulsifying solution. The invention also concerns a cold mix obtained by mixing aggregates, optionally fillers, optionally pigments with an emulsion of clear synthetic binder such as defined above. Finally, the invention concerns the use of a clear synthetic binder such as defined above, for the manufacture of coloured surfacing for roads, carriageways, pavements, street networks, urban landscaping, hard surfaces, waterproofing of buildings and structures, in particular in roadway applications for the manufacture of surfacing layers such as binder courses and/or wearing courses.

### DETAILED DESCRIPTION

The clear synthetic binder according to the invention, as essential component, comprises one or more oils of plant origin, taken alone or in mixtures. These oils are plasticizing agents for the clear synthetic binder, they allow fluidifying of the synthetic binder, a reduction in its viscosity and an improvement in its handling and mechanical properties.

The oil of plant origin is chosen from among canola, sunflower, soybean, flax, olive, palm, castor, corn, pumpkin seed, grape seed, jojoba, sesame, walnut, hazelnut, almond, shea, macadamia, cotton, alfalfa, rye, safflower, groundnut, coconut and copra oils, taken alone or in mixtures. Preferably, the oil of plant origin is chosen from among canola, sunflower, flax, coconut, soybean oils taken alone or in mixtures, preferably from among canola, sunflower and soya bean oils taken alone or in mixtures.

The oils of plant origin according to the invention comprise trimesters of fatty acids (such as the triglycerides of fatty acids for example), diesters of fatty acids, monoesters of fatty acids and fatty acids in free from (unesterified). The oils of plant origin according to the invention preferably comprise a large quantity of free, unesterified fatty acids. Preferably the oil of plant origin according to the invention comprises 10 to 90 weight % of free fatty acids, relative to the weight of the oil of plant origin, preferably from 20 to 80%, more preferably from 30 to 70% and further preferably from 40 to 60%. The oil of plant origin according to the invention in this case comprises from 1 to 30% fatty acid triglycerides, preferably from 2 to 25%, more preferably from 5 to 20%. The oil of plant origin according to the invention in this case comprises from 1 to 20% of fatty acid diglycerides, preferably from 2 to 15%, further preferably from 5 to 10%. The oil of plant origin according to the invention in this case comprises from 1 to 5% of fatty acid monoglycerides, preferably from 1 to 2%.

In a second embodiment, the oils of plant origin according to the invention preferably comprise a small quantity of free, unesterified fatty acids. Preferably the oil of plant origin according to the invention comprises 0.1 to 5 weight % of free fatty acids relative to the weight of oil of plant origin, preferably from 0.2 to 3%, more preferably from 0.4 to 2%, further preferably from 0.5 to 1%. The oil of plant origin according to the invention therefore comprises from 85 to 99.7% of fatty acid triglycerides, preferably 91 to 99.4%, more preferably from 94 to 98.8% and further preferably from 97 to 98.5%. The oil of plant origin according to the invention in this case comprises 0.1 to 5% of fatty acid diglycerides, preferably from 0.2 to 3%, more preferably from 0.4 to 2% and further preferably from 0.5 to 1%. The oil of plant origin according to the invention in this case comprises from 0.1 to 5% of fatty acid monoglycerides, preferably from 0.2 to 3%, more preferably from 0.4 to 2%, further preferably from 0.5 to 1%. These two embodiments can be combined with all the characteristics of the oil of plant origin given above and below.

The fatty acids of the oils of plant origin according to the invention are saturated, mono-unsaturated and/or poly-unsaturated fatty acids. The fatty acids of the oils of plant origin according to the invention are fatty acids comprising from 14 to 24 carbon atoms, preferably from 16 to 22 carbon atoms, more preferably from 18 to 20 carbon atoms, the fatty acids comprising 18 carbon atoms being the major fatty acids. Preferably, the quantity of fatty acids comprising 16 carbon atoms lies between 1 and 20 weight % relative to the weight of the oil of plant origin, preferably between 5 and 10%. Preferably the quantity of fatty acids comprising 18 carbon atoms lies between 30 and 90 weight % relative to the weight of the oil of plant origin, preferably between 40 and 80%, more preferably between 50 and 70% and further preferably between 60 and 80%. Preferably the quantity of fatty acids comprising 18 carbon atoms with no degree of unsaturation (C18:0) lies between 1 and 10 weight %, preferably between 1 and 5 weight relative to the weight of the oil of plant origin. Preferably the quantity of fatty acids comprising 18 carbon atoms and one degree of unsaturation (C18:1) lies between 40 and 60 weight % relative to the weight of the oil of plant origin, preferably between 30 and 50%, more preferably between 20 and 40%. Preferably the quantity of fatty acids comprising 18 carbon atoms and two degrees of unsaturation (C18:2) lies between 5 and 60 weight relative to the weight of the oil of plant origin, preferably between 8 and 40% more preferably between 10 and 30%. Preferably the quantity of fatty acids comprising 18 carbon atoms and three degrees of unsaturation (C18:3) lies between 5 and 15 weight % relative to the weight of the oil of plant origin, preferably between 7 and 10%.

Preferably the oil of plant origin is chosen from among acid oils i.e. oils with high acid number. Preferably the acid number of the oils ranges from 50 to 300 mg KOH/g preferably from 80 to 200, more preferably from 100 to 150. Preferably the oil of plant origin is chosen from among oils having a dynamic viscosity at 25° C. of between 50 and 500 mPA·s, preferably between 80 and 300 mPa·s, more preferably between 100 and 200 mPa·s. Preferably the oil of plant origin is chosen from among oils having a dynamic viscosity at 40° C. of between 15 and 300 mPa·s, preferably between 20 and 200 mPa·s, more preferably between 25 and 100 mPa·s.

Preferably the oil of plant origin is chosen from among oils having a dynamic viscosity at 50° C. of between 10 and 200 mPa·s, preferably between 20 and 100 mPa·s, more preferably between 30 and 80 mPa·s. Preferably the oil of plant origin is chosen from among oils having a dynamic viscosity at 60° C. of between 5 and 100 mPa·s, preferably between 10 and 50 mPa·s, more preferably between 15 and 30 mPa·s. The viscosity of the oil of plant origin is an important parameter since the more the oil of plant origin is viscous, the more the clear synthetic binder will have consistency.

Preferably the oil of plant origin is chosen from among oils having an iodine number of between 0 and 200 g/100 g, preferably between 50 and 150, more preferably between 70 and 120. Preferably the oil of plant origin is chosen from among oils having a colour on the maximum Lovibond red scale of 5, preferably of 2.5 more preferably of 1.5. In addition, the oil of plant origin is chosen from among oils having a colour on the maximum Lovibond yellow scale of 25, preferably of 20 and further preferably of 15. Preferably the oil of plant origin is chosen from among oils having a maximum water content of 2 weight % relative to the weight of the oil of plant origin, preferably of 1%, more preferably of 0.5%, further preferably of 0.05%.

The oils of plant origin can be crude oils, semi-refined oils, refined oils, co-products of semi-refined oils and/or co-products of refined oils, taken alone or in mixtures. Preference is given to semi-refined oils, refined oils and their co-products which are clearer and allow easier colouring of the clear synthetic binder. The semi-refined oils, refined oils and their co-products undergo chemical or physical refining. With chemical refining, the oils are degummed, neutralized, washed, dried, bleached, filtered and deodorized. With physical refining the oils are degummed, bleached filtered and deodorized. The semi-refined oils, the refined oils and their co-products undergo some or all of the above treatments. By co-products of semi-refined oils and/or co-products of refined oils is meant products obtained at the same time as said oils throughout their refining process. The oils of plant origin can also be modified by chemical reactions such as esterification or hydrogenation reactions. Preferably the oil of the invention is oil which has undergone physical refining and in particular which has undergone degumming, bleaching, filtering, deodorization and/or neutralization operations. In particular the oil of the invention is refined soybean oil.

Preferably the clear synthetic binder of the invention comprises 10 to 70 weight % of oil of plant origin relative to the weight of clear synthetic binder, preferably from 20 to 60 weight %, more preferably from 30 to 50 weight %, further preferably from 10 to 50 weight %. These quantities of oil of plant origin allow the clear synthetic binder to be sufficiently fluid. A smaller quantity of oil of plant origin would give a clear synthetic binder that is too viscous, and a higher quantity would give a clear synthetic binder that is too liquid or too soft.

Preferably the clear synthetic binder of the invention comprises a negligible quantity of oil of petroleum origin (less than 10 weight % relative to the weight of clear synthetic binder, preferably less than 5 weight %, more preferably less than 2% and further preferably less than 1%). Preferably the clear synthetic binder of the invention is free of oil of petroleum origin.

The clear synthetic binder of the invention, as other essential component, comprises one or more resins of petroleum origin. These resins are structuring agents for the clear synthetic binder and impart consistency i.e. they increase their Ball and Ring temperature and reduce their penetration value. By resins of petroleum origin is meant hydrocarbon resins chosen from among co/homo-polymers of low molecular weight (typically between 300 g/mol and 10 000 g/mol), with a polydispersity of more than 1 and with a high glass transition temperature (typically between 30° C. and 100° C.).

The resins of petroleum origin are obtained from crude oil in particular from petroleum fractions derived from the distillation of crude oil. The petroleum fractions which can be used are light petroleum fractions derived from the so-called “naphta” fraction whose boiling point ranges from 60° C. to 200° C. These petroleum fractions may be aromatic petroleum fractions, aliphatic petroleum fractions or cyclopentadiene petroleum fractions. These petroleum fractions, after distillation of crude oil, are cracked and separated to yield different monomers which are then polymerized to give so-called petroleum resins. Aromatic petroleum fractions will yield a majority of aromatic monomers, whereas aliphatic petroleum fractions will yield a majority of aliphatic monomers.

The resins of petroleum origin may therefore be classified depending on the type of monomers they contain: the aliphatic monomers such as isoamylene, isoprene, piperylene, the aromatic monomers such as styrene, α-methylstyrene, vinyltoluene, indene, coumarone, methylindene, the dicyclopentadiene monomers or terpene monomers. These different monomers are combined together to give different types of resins such as indene resins for example derived from the polymerisation of indene monomers and monomers chosen from among styrene, methylstyrene, methylindene and mixtures thereof. Among the indene resins, preference is given to indene/styrene resins derived from the polymerisation of indene monomers and styrene monomers.

The preferred resins of petroleum origin are therefore resins derived from the co-polymerisation of aromatic petroleum fractions comprising a majority of aromatic monomers. After polymerisation, the resins of petroleum origin can be modified (for example with phenol or maleic anhydride) or they may undergo chemical treatments such as hydrogenation for example.

The resins of petroleum origin according to the invention have a softening point (ISP 4625) of between 90° C. and 220° C., preferably between 110° C. and 200° C., more preferably between 130° C. and 180° C., further preferably between 140° C. and 170° C. and still further preferably between 150° C. and 160° C. It is important to choose a resin of petroleum origin having a fairly high softening point to give consistency to the clear synthetic binder i.e. so that the clear binder has a high Ball and Ring temperature and low penetration value. The resins of petroleum origin according to the invention have a Brookfield viscosity measured at 160° C. of between 15 000 mPa·s and 200 000 mPa·s, preferably between 30 000 mPa·s and 150 000 mPa·s, more preferably between 50 000 mPa·s and 90 000 mPa·s. The resins of petroleum origin according to the invention have a Brookfield viscosity measured at 200° C. of between 600 mPa·s and 4000 mPa·s, preferably between 1200 mPa·s and 3000 mPa·s, more preferably between 2000 mPa·s and 2500 mPa·s.

Preferably the clear synthetic binder according to the invention comprises 15 to 75 weight % resin of petroleum origin relative to the weight of clear synthetic binder, preferably between 30 and 70 weight %, more preferably between 40 and 60 weight %. A smaller quantity of resin of petroleum origin would give a clear synthetic binder that is too soft, and a higher quantity would give a synthetic clear binder that is too viscous.

Preferably, the ratio between the weight quantities of oil of plant origin and resin of petroleum origin lies between 0.2 and 5, preferably between 0.5 and 4, more preferably between 0.6 and 2, further preferably between 0.7 and 1. The ratio between the oil of plant origin and the resin of petroleum origin allows a clear synthetic binder to be obtained that displays a good compromise between consistency and viscosity.

Preferably, the clear synthetic binder of the invention comprises a negligible quantity of resin of plant origin (less than 10 weight relative to the weight of clear synthetic binder, preferably less than 5%, more preferably less than 2%, further preferably less than 1%). Preferably the clear synthetic binder of the invention is free of resin of plant origin. The clear synthetic binder of the invention, as other essential component, comprises one or more polymers taken alone or in mixtures. These polymers are also structuring agents like the resins of petroleum origin, but they additionally impart elastic properties to the clear synthetic binder.

The polymers which can be used for the invention are elastomers and/or plastomers taken alone or in mixtures. Mention may be made for example, by way of indication but in non-limiting manner, of the statistical or sequenced co-polymers of styrene and butadiene, whether linear or star-branched (SBR,SBS) or of styrene and isoprene (SIS), the copolymers of ethylene and vinyl acetate (EVA), the copolymers of ethylene and methyl acrylate (EMA), the copolymers of ethylene and butyl acrylate (EBA), the copolymers of ethylene and maleic anhydride, the copolymers of ethylene and glycidyl methacrylate, the copolymers of ethylene and glycidyl acrylate, the copolymers of ethylene and propene, the terpolymers ethylene/propene/diene (EPDM), the terpolymers acrylonitrile/butadiene/styrene (ABS), the terpolymers ethylene/alkyl acrylate or alkyl methacrylate/glycidyl acrylate or glycidyl methacrylate (e.g. ethylene/methyl acrylate/glycidyl methacrylate terpolymers), the terpolymers ethylene/alkyl acrylate or alkyl methacrylate/maleic anhydride (e.g. ethylene/butyl acrylate/maleic anhydride terpolymers), the ethylene (or propylene, or butylene) olefin homopolymers and copolymers, the polyisobutylenes, polybutadienes (PB), polyisoprenes (PI), polyvinyl chlorides, rubber crumb, butyl rubbers, polyacrylates, polymethacrylates, polychloroprenes, polynorbornenes, polybutenes, polyisobutenes, polyethylenes (PE), polypropylenes (PP), atactic polypropylenes (APP) or any polymer used to modify bitumen and mixtures thereof.

Preferably, the clear synthetic binder of the invention comprises from 1 to 15 weight % of polymer relative to the weight of clear synthetic binder, preferably from 2 to 10 weight %, more preferably from 3 to weight %. A quantity of polymer higher than the above values is not suitable for the formulation of clear synthetic binders according to the invention. Indeed, if the quantity of polymer added to the mixture of oil of plant origin/resin of petroleum origin is too high, it will not be able solubilise correctly in the mixture of oil of plant origin/resin of petroleum origin, and the corresponding clear synthetic binder would therefore not be homogeneous. In addition if the added quantity of polymer is too high, although it is true that the elastic properties will be very satisfactory, the viscosity of the clear synthetic binder would be too high. An amount of polymer lower than the above values is not adapted either to the formulation of clear synthetic binders according to the invention. If the quantity of polymer is too low, the clear synthetic binder will not have adequate elastic properties.

The preferred polymers are the copolymers of styrene and butadiene, the copolymers of styrene and isoprene, the ethylene/propene/diene terpolymers, the polychloroprenes, the copolymers of ethylene and vinyl acetate, the copolymers of ethylene and methyl acrylate, the copolymers of ethylene and butyl acrylate, the ethylene/methyl acrylate/glycidyl methacrylate terpolymers, the ethylene/butyl acrylate/maleic anhydride terpolymers, the atactic polypropylenes, taken alone or in a mixture. The preferred polymers are the copolymers of styrene and butadiene, and the copolymers of ethylene and vinyl acetate, used alone or in mixtures. Preferably, a mixture of polymers is used, preferably a mixture of an “elastomer” polymer and a “plastomer” polymer. If an elastomer/plastomer mixture is used, the ratio between the weight quantities of elastomer and plastomer lies between 0.25 and 2, preferably between 0.5 and 1. A 50/50 mixture by weight of the two polymers is preferred.

Preferably, a mixture of styrene/butadiene (elastomer) copolymers and ethylene/vinyl acetate copolymers (plastomer) is used. Preferably, the ratio between the weight quantities of styrene and butadiene copolymers and ethylene and vinyl acetate copolymers lies between 0.25 and 2, preferably between 0.5 and 1. A 50/50 mixture by weight of the two polymers is preferred.

The use of a mixture of an elastomer (e.g. with a styrene/butadiene copolymer) and a plastomer (e.g. with a copolymer of ethylene/vinyl acetate) allows good elastic properties to be achieved (by means of the elastomer) without too great an increase in viscosity however (by means of the plastomer). When the clear synthetic binder comprises a styrene/butadiene copolymer, it is also possible to cross-link this copolymer with sulphur either alone or in a mixture with vulcanisation accelerators. The proportions of oil of plant origin, of resin of petroleum origin and of polymer in the clear synthetic binder are adjusted to obtain a good compromise between viscosity, consistency and elasticity. It is to be noted that the oil of plant origin, the resins of petroleum origin and the selected polymers are compatible with each other, and that the clear synthetic binders of the invention are therefore fully homogeneous and stable when stored.

The clear synthetic binder of the invention may also comprise one or more colouring agents such as mineral pigments and organic colouring agents. The pigments are chosen depending upon the shade, the colour it is desired to give to the surfacing. For example metallic oxides can be used such as iron oxides, chromium oxides, cobalt oxides, titanium oxides to obtain red, yellow, grey, green, blue or white colouring. The pigments can be added indifferently to the clear synthetic binder, to the mix (in a mixture with the aggregates for example) or to the emulsion of clear synthetic binder.

The clear synthetic binder of the invention may also comprise one or more adhesion agents chosen from among the alkyl-polyamines such as the alkyl amido-polyamines or alkyl imidazo-polyamines. The adhesion agents are added to the clear synthetic binder and/or to the emulsion of clear synthetic binder. When they are added to the clear synthetic binder, they represent a quantity by weight of between 0.1 and 1 weight %, relative to the weight of clear synthetic binder, preferably between 0.2 and 0.5 weight %.

The clear synthetic binder according to the invention may also comprise fatty acids and resin acids obtained by distilling Tall-Oil. These are added to the clear synthetic binder, and represent a quantity by weight of between 0.1% and 2 weight %, relative to the weight of the clear synthetic binder, preferably between 0.5% and 1 weight %. Preferably, the clear synthetic binder of the invention has a penetration value at 25° C., measured as per standard NF EN 1426, of between 10 and 300 1/10 mm, preferably between 30 and 200 1/10 mm, more preferably between 50 and 160 1/10 mm, further preferably between 70 and 100 1/10 mm. Preference is given to a clear synthetic binder having a penetration value of between 30 and 70 1/10 mm. Preferably, the clear synthetic binder of the invention has a Ball and Ring softening point, measured as per standard NF EN 1427, of between 40° C. and 130° C., preferably between 60° C. and 100° C.

A further subject of the invention is a method for preparing a clear synthetic binder comprising the following steps:

(i) mixing and heating oil of plant origin at a temperature of between 140° C. and 200° C., preferably between 160° C. and 180° C.,
(ii) gradually adding resin of petroleum origin, mixing and heating at a temperature of between 140° C. and 200° C., preferably at between 160° C. and 180° C., from 30 minutes to 2 hours,
(iii) adding the polymer(s), mixing and heating to a temperature of between 140° C. and 200° C., preferably between 160° C. and 180° C., for 30 minutes to 2 hours,
(iv) optionally adding an adhesion agent, mixing and heating to a temperature of between 140° C. and 200° C., preferably between 160° C. and 180° C., for 30 minutes to 2 hours.

The clear synthetic binder according to the invention can be used and applied indifferently using so-called “hot techniques or so-called “cold” techniques. By hot techniques is meant techniques in which the clear synthetic binder, at the time of application, is brought to relatively high temperatures. Hot techniques lead to so-called “hot” surface dressings, asphalts and mixes such as road base asphalt, high modulus asphalt, sand mastic, semi-coarse asphaltic concrete, high modulus asphaltic concrete, soft asphaltic concrete, thin asphaltic overlay, porous asphalt, very thin asphaltic overlay, ultra-thin asphaltic overlay. The clear synthetic binder of the invention is adapted for preparing the mixes, asphalts and surface dressings mentioned above.

A further subject of the invention therefore concerns mixes comprising a clear synthetic binder according to the invention, aggregates, optionally fillers and optionally pigments. The fillers (or fines) are particles of size less than 0.063 mm. The aggregates comprise particles of sizes 0/2 (sand), 2/4 (gravel), 4/6 and 6/10. The mix comprises 1 to 10 weight % of clear synthetic binder relative to the total weight of the mix, preferably 4 to 8 weight %, the remainder consisting of aggregate, optionally fillers and optionally pigments (the pigments representing a weight quantity of 0 to 1% of the mix, the fillers representing a weight quantity of 0 to 2% of the mix).

A further subject of the invention concerns mastic asphalts comprising a clear synthetic binder according to the invention, mineral fillers and optionally pigments. The asphalt comprises 1 to 20 weight % of clear synthetic binder, relative to the total weight of the asphalt, preferably from 5 to 10 weight %, the remainder consisting of fillers and optionally pigments (the quantity of pigments representing 0 to 1 weight % of the asphalt).

By means of the low viscosity of the clear synthetic binder of the invention, the method for preparing hot mixes or asphalts is characterized by lower temperatures than conventional methods for preparing hot mixes or asphalts. Indeed, according to conventional methods for preparing hot mixes (or asphalts) first the binder is mixed with the aggregates, optionally with fillers and optionally with pigments (without aggregate for asphalts) at a so-called manufacture or mix temperature of the order of 160° C. to 180° C. for mixes and of the order of 200° C. to 250° C. for asphalts. The mixture of binder/aggregate/fillers/pigments or binder/fillers/pigments is then sprayed (for mixes) or poured (for asphalts) at a so-called laying temperature of the order of 140° C. to 160° C. for mixes and of the order of 180° C. to 230° C. for asphalts. For mixes there follows a compacting step at a so-called compacting temperature of the order of 130° C. to 140° C. After compacting the mix, or pouring the asphalt, the mix or asphalt are cooled to ambient temperature.

The method for preparing mixes according to the invention is characterized by a manufacture temperature of between 100° C. and 160° C., preferably between 120° C. and 140° C., a laying temperature of between 80° C. and 140° C., preferably between 100° C. and 120° C., a compacting temperature of between 70° C. and 130° C. preferably between 90° C. and 110° C. The method for preparing asphalts according to the invention is characterized by a manufacture temperature of between 140° C. and 180° C., preferably between 150° C. and 170° C., a laying temperature of between 120° C. and 160° C., preferably between 130° C. and 150° C. The preparation methods according to the invention therefore allow energy expenditure and smoke emission to be reduced when preparing mixes or asphalts according to the invention.

By cold techniques is meant techniques based on the use of emulsions of clear synthetic binder in aqueous phase, at lower temperatures. Cold techniques lead to surface dressings, slurries, cold micro asphalt concrete surfacing, cold mixes, cold asphaltic concrete, grave emulsions, cold mixes with storage capability. The clear synthetic binder according to the invention is adapted for the preparation of the above-mentioned products.

A further subject of the invention is an emulsion of clear synthetic binder comprising a clear synthetic binder, water and an emulsifying agent. The clear synthetic binder comprises at least one oil of plant origin, at least one resin of petroleum origin and at least one polymer such as defined above.

A further subject of the invention is therefore a method for preparing an emulsion of clear synthetic binder comprising:

(i) preparing a clear synthetic binder by mixing at least one oil of plant origin, at least one resin of petroleum origin and a least one polymer such as defined above,
(ii) preparing an emulsifying solution by mixing water and the emulsifying agent
(iii) dispersing the clear synthetic binder of step (i) in the emulsifying solution of step (ii).

The emulsion of clear synthetic binder comprises 50 to 80 weight % of clear synthetic binder, preferably from 60% to 70%. Yet a further subject of the invention therefore concerns cold mixes obtained by mixing the emulsion of clear synthetic binder with aggregate, optionally with fillers and optionally pigments. The invention also concerns surface dressings obtained with the emulsion of clear synthetic binder, aggregate, optionally fillers and optionally pigments.

### EXAMPLES

### Preparation of Clear Synthetic Binders According to the Invention

The oil of plant origin is heated to about 180° C., the resin of petroleum origin is gradually incorporated in the oil of plant origin. The mixture is heated to 180° C. for 1 hour. The polymer(s) is/are then added and the mixture is again heated to 180° C. for 1 hour and 30 minutes. An adhesion agent is then added and the mixture is again heated to 180° C. for 1 hour.

Preparation of Control Clear Synthetic Binders

The control clear synthetic binders are prepared in similar manner from an oil of petroleum origin and not an oil of plant origin. The different oils used to formulate the clear synthetic binders are given in Table 1 below:

TABLE 1

| Reference | Type |
|---|---|
| Oil A | Oil of petroleum origin |
| Oil B | Oil of plant origin |
| | (acid canola oil comprising 54% fatty acids in free form) |
| Oil C | Oil of plant origin |
| | (sunflower oil comprising 85% fatty acids in free form) |
| Oil D | Oil of plant origin |
| | (soybean oil comprising 0.1% fatty acids in free form) |

The resins of petroleum origin used to formulate the clear synthetic binders are indene/styrene resins. The polymers used are polymers of styrene-butadiene type (hereinafter called polymers S) and polymers of ethylene-vinyl acetate type (hereinafter polymers E). The adhesion agents are alkyl amido-polyamines and alkyl imidazo-polyamines.

From these different components, different clear synthetic binders are formulated. The compositions of the clear synthetic binders L₁ to L₈ are given in Table 2 below (weight %):

TABLE 2
Composition of the clear synthetic binders

| | L₁ | L₂ | L₃ | L₄ | L₅ | L₆ | L₇ | L₈ |
|---|---|---|---|---|---|---|---|---|
| Oil A | 61.8 | — | — | — | — | — | — | — |
| Oil B | — | 38.8 | 38.8 | 38.8 | — | — | — | — |
| Oil C | — | — | — | — | 35.8 | 33.8 | 35.5 | — |
| Oil D | — | — | — | — | — | — | — | 36.3 |
| Resin | 33 | 56 | 56 | 56 | 59 | 61 | 59.3 | 60.5 |
| Polymer S | 5 | — | 5 | 2.5 | — | 5 | 2.5 | 3.0 |
| Polymer E | — | 5 | — | 2.5 | 5 | — | 2.5 | — |
| Adhesion agent | 0.2 | 0.2 | 0.2 | 0.2 | 0.2 | 0.2 | 0.2 | 0.2 |

The physical, mechanical and rheological properties of the clear synthetic binders L₁ to L₈ are given in Table 3 below:

TABLE 3
Properties of the clear synthetic binders

| Properties | L₁ | L₂ | L₃ | L₄ | L₅ | L₆ | L₇ | L₈ |
|---|---|---|---|---|---|---|---|---|
| Penetration | 60 | 58 | 83 | 57 | 58 | 50 | 64 | 57 |
| value | | | | | | | | |
| ( 1/10 mm)⁽¹⁾ | | | | | | | | |
| Ball and Ring | 52.0 | 49.8 | 45.4 | 49.2 | 50.4 | 54.4 | 50.2 | 49.5 |
| temperature | | | | | | | | |
| (° C.)⁽²⁾ | | | | | | | | |
| Viscosity | 470 | 108 | 156 | 146 | 120 | 276 | 180 | 238 |
| at 160° C. | | | | | | | | |
| (mPa · s)⁽³⁾ | | | | | | | | |
| Viscosity | 880 | 262 | 289 | 286 | 272 | 562 | 402 | 477 |
| at 140° C. | | | | | | | | |
| (mPa · s)⁽³⁾ | | | | | | | | |
| Critical BBR | −23.0 | — | — | −28.1 | — | — | −26.4 | −28.5 |
| temperature⁽⁴⁾ | | | | | | | | |
| Elastic | 83.0 | 6.1 | 77.6 | 49.6 | 4.2 | 69.3 | 44.3 | 57.0 |
| recovery⁽⁵⁾ | | | | | | | | |

⁽¹⁾P₂₅ penetration measured at 25° C. as per standard EN 1426
⁽²⁾Ball and Ring temperature measured as per standard EN 1427
⁽³⁾Viscosity at 160° C. measured as per standard NG EN 13702-1
⁽⁴⁾BBR “Bending Beam Rheometer” measured as per standard NF EN 14771 under loading of 300 MPa and 60 s.
⁽⁵⁾Elastic recovery measured as per standard NF EN 13398.

It is ascertained that the substitution of oil of petroleum origin by an oil of plant origin does not deteriorate the consistency of the binders L₂ to L₈. The penetration value and Ball and Ring temperature of these binders are equivalent to those of binder L₁.

The viscosity of binder L₁ at 160° C. and 140° C. is much higher than the viscosity of binders L₂ to L₈ according to the invention. The clear synthetic binders L₂ to L₈ according to the invention may therefore be handled at lower temperature, and during the manufacture of hot mixes with these clear synthetic binders L₂ to L₈ of the invention, the manufacturing (or mixing), laying and compacting temperatures can be reduced. Typically, instead of heating the clear synthetic binder and aggregate to 160° C., it is possible to heat the synthetic clear binders L₂ to L₈ according to the invention and the aggregates to a temperature of between 120° C. and 140° C. which will allow energy savings and smoke reductions at the time of application.

The critical temperature values of the clear synthetic binders L₂ to L₈ of the invention, measured using the Bending Beam Rheometer test, are lower than those of the control binder L₁, which means that the clear synthetic binders of the invention L₂ to L₈ have better cold-temperature properties and better withstand thermal cracking. For example the binder L₄ has a critical temperature of −28.1° C. and binder L₁ has a critical temperature of −23° C. This means that the first cracking under 300 MPa loading and 60 s for binder L₄ would appear at −28.1° C., whereas for binder L₁ the onset would be at −23° C.

The clear synthetic binders formulated from the styrene/butadiene copolymer (binders L₃, L₆ and L₈) have very good elastic properties compared with the clear synthetic binders formulated from the ethylene/vinyl acetate copolymer (binders L₂ and L₅) but they are also a little more viscous. The combination of the two copolymers provides a good compromise between elastic properties and viscosity (binders L₄ and L₇).

The clear synthetic binders were subjected to a storage stability test in accordance with standard NF EN 13399 at 160° C. The clear synthetic binders L₄, L₇ and L₈ were heated to 160° C. for 3 days in so-called “toothpaste” tubes. Once cooled, and for each binder, the tube was cut into 3 equal parts and the penetration value was determined at 25° C. as per standard EN 1426 and the Ball and Ring temperature as per standard EN 1427 at each of the two ends of the tube (Upper Part and Lower Part). The differences between the penetration values and Ball and Ring temperatures of the upper part and lower part of the tube give an indication of the stability of the clear synthetic binders L₄, L₇ and L₈. The results of the stability tests are given in Table 4 below:

TABLE 4
Storage stability of the clear synthetic binders

| Storage stability at 160° C. ⁽⁶⁾ | L₄ | L₇ | L₈ |
|---|---|---|---|
| Penetration-Upper (1/10 mm) ⁽¹⁾ | 71 | 76 | 56 |
| Penetration-Lower (1/10) mm ⁽¹⁾ | 69 | 75 | 55 |
| Ball and Ring temperature-Upper (° C.) ⁽²⁾ | 52 | 51 | 50.3 |
| Ball and Ring temperature-Lower (° C.) ⁽²⁾ | 49 | 50 | 50.4 |

⁽⁶⁾ Storage stability measured as per standard NF E 13399 at 160° C.

It is ascertained that the clear synthetic binders L₄, L₇ and L₈ are stable when stored since the penetration values and Ball and Ring temperatures of the upper and lower parts of the tubes are very close.

The clear synthetic binders were subjected to an RTFOT ageing test (Rolling Thin Film Oven Test) following standard NF EN 12607-1. The properties of the clear synthetic binders after the RTFOT test are given in Table 5 below:

TABLE 5
Properties of the clear synthetic binders after RTFOT

| | L₄ | L₇ | L₈ |
|---|---|---|---|
| Penetration at 25° C. | 42 | 45 | 51 |
| (1/10 mm) ⁽¹⁾ | | | |
| Remaining penetration | 73 | 70 | 89 |
| (%) ⁽⁷⁾ | | | |
| Ball and Ring temperature | 59.6 | 53.5 | 48.7 |
| (BRT) (° C.) ⁽²⁾ | | | |
| BRT variation (° C.) ⁽⁷⁾ | 10.4 | 3.3 | 0.8 |

⁽¹⁾ Penetration P25 measured at 25° C. as per standard EN 1426
⁽²⁾ Ball and Ring temperature measured as per standard EN 1427
⁽⁷⁾ As per standard EN 12607-1

It is ascertained that the clear synthetic binders L₇ and L₈ have good resistance to ageing. The clear synthetic binders L₇ and L₈ will have moderate hardening during mixing at the coating station.

Next, the colour fastness of the clear synthetic binders L₄ and L₇ was compared before and after RTFOT using a chroma meter which performs measurement on the Hunter scale “L,a,b”. The results are given in Table 6 below:

TABLE 6
Colour difference measurement

| Clear synthetic binder | ΔE | ΔL | Δa | Δb |
|---|---|---|---|---|
| L₄ | +2.01 | −1.89 | +0.6 | +0.36 |
| L₄ + 1% green pigments | +0.83 | +0.53 | +0.52 | −0.38 |
| L₄ + 1% red pigments | +5.14 | −2.66 | −3.45 | −2.74 |
| L₇ | +5.71 | −3.1 | +4.1 | −2.5 |
| L₇ + 1% green pigments | +5.65 | −3.6 | +2.3 | −3.7 |
| L₇ + 1% red pigments | +0.60 | −0.6 | −0.1 | 0 |

The total difference in colour ΔE between the clear synthetic binders before and after RTFOT gives an indication of the resistance of the colour of the clear synthetic binders during the mixing step at the coating station. It is ascertained that the differences in colour ΔE between the clear synthetic binders before and after RTFOT are small (less than 6). In particular, the clear synthetic binders L₄ to which green pigments are added and L₇ to which red pigments are added have colour differences ΔE that are particularly small (less than 1) which means that the colour of these clear synthetic binders well withstood the coating step, that there is no difference visible to the naked eye between the colour of the clear synthetic binder before the coating step and the colour of the clear synthetic binder after the coating step.

Preparation of Control Mixes and Mixes of the Invention

Mixes were then prepared from the clear synthetic binders defined above:

a control mix E₁ by mixing 92.7 weight % of aggregate, 2 weight % of filler and 5.3 weight % of clear synthetic binder L₁, at the manufacture or coating temperature of 180° C., the aggregate and the clear synthetic binder both being at the temperature of 180° C. for 90 seconds. The mixture of clear synthetic binder/aggregate was then sprayed at 160° C., compacted at 150° C. and cooled to ambient temperature.

a mix according to the invention E₄ by mixing 92.7 weight % of aggregate, 2 weight % of filler and 5.3 weight % of clear synthetic binder L₄ at the manufacture or coating temperature of 140° C., the aggregate and the clear synthetic binder both being at the temperature of 140° C. for 90 seconds. The mixture of clear synthetic binder/aggregate was then sprayed at 120° C., compacted at 110° C. and cooled to ambient temperature.

a mix according to the invention E₈ by mixing 92.7 weight % of aggregate, 2 weight % of filler and 5.3 weight % of synthetic binder L₈ at the manufacture or coating temperature of 140° C., the aggregate and the clear synthetic binder both being at the temperature of 140° C. for 90 seconds. The mixture of clear synthetic binder/aggregate was then sprayed at 120° C., compacted at 110° C. and cooled to ambient temperature.

For the mixes, the particle size of the aggregate was as follows: 35.0% of 0/2 aggregate (or sand); 9.2% of 2/4 aggregate, 11.2% of 4/6 aggregate and 36.8% of 6/10 aggregate (% relative to the mix).

The properties of the mixes obtained from the clear synthetic binders are given in Table 7 below.

TABLE 7
Properties of the hot mixes

| | E₁ | E₄ | E₈ |
|---|---|---|---|
| Duriez test ⁽⁸⁾ | | | |
| Void content (%) | 11.1 | 8.9 | 10 |
| R (MPa) | 10.9 | 6.8 | 7 |
| r (MPa) | 9.9 | 6.2 | 5.8 |
| r/R | 0.9 | 0.91 | 0.82 |
| Rutting test ⁽⁹⁾ | | | |
| Test-piece void content (%) | 6.8 | 6.4 | 6.3 |
| Thickness of test-piece (cm) | 10 | 10 | 10 |
| Rutting at 100 cycles (%) | 2.7 | 2.6 | 2.2 |
| Rutting at 300 cycles (%) | 3.5 | 3.4 | 2.9 |
| Rutting at 1000 cycles (%) | 4.6 | 4.2 | 4 |
| Rutting at 3000 cycles (%) | 6.9 | 5.4 | 5.9 |
| Rutting at 10 000 cycles (%) | 13.0 | 8.3 | 9.4 |
| Rutting at 30 000 cycles (%) | 16.0 | 10.8 | 11.3 |

⁽⁸⁾ Resistance to water stripping as per standard NF P 98-251-1 reflects the adhesion between binder and aggregate
⁽⁹⁾ Rutting resistance as per standard NF EN 12697-22 reflects the capability of the mix to resist deformations caused by the passing of vehicles notably heavy vehicles.

It is ascertained that the preparation of mix E₄ according to the invention and of mix E₈ according to the invention at lower temperatures does not deteriorate the resistance to water stripping. The r/R ratios are equivalent for the mixes E₁ and E₄.

Similarly, it is ascertained that the preparation of mix E₄ according to the invention and of mix E₈ according to the invention at lower temperatures does not deteriorate the rutting resistance of mix E₄ according to the invention and of mix E₈ according to the invention. They even show much better resistance to deformation by road traffic than the control mix E₁, the rutting percentage for mix E₄ always being lower, irrespective of the number of cycles, than the rutting percentage for mix E₁ (similarly for E₈). The clear binder according to the invention therefore allows the use of lower temperatures to prepare a mix having very good resistance to rutting for the intended application (clear synthetic binder).

1-18. (canceled)

19. A clear synthetic binder comprising at least one oil of plant origin, at least one resin of petroleum origin and at least one polymer, the quantity of oil of plant origin in the binder being equal to or more than 10 weight % and the quantity of polymer in the binder being equal to or less than 15 weight %.

20. The clear synthetic binder according to claim 19, wherein the quantity of oil of plant origin in the binder lies between 10 and 70 weight %.

21. The clear synthetic binder according to claim 19, comprising less than 10 weight %, relative to the weight of clear synthetic binder of oil of petroleum origin, and most advantageously it is free of oil of petroleum origin.

22. The clear synthetic binder according to claim 20, comprising less than 10 weight %, relative to the weight of clear synthetic binder of oil of petroleum origin, and most advantageously it is free of oil of petroleum origin.

23. The clear synthetic binder according to claim 19, wherein the quantity of polymer in the binder lies between 1 and 15 weight %.

24. The clear synthetic binder according to claim 20, wherein the quantity of polymer in the binder lies between 1 and 15 weight %.

25. The clear synthetic binder according to claim 19, wherein the quantity of resin of petroleum origin in the binder lies between 15 and 75 weight %.

26. The clear synthetic binder according to claim 19, wherein the ratio between the weight quantities of oil of plant origin and resin of petroleum origin lies between 0.3 and 2.

27. The clear synthetic binder according to claim 21, wherein the ratio between the weight quantities of oil of plant origin and resin of petroleum origin lies between 0.3 and 2.

28. The clear synthetic binder according to claim 22, wherein the ratio between the weight quantities of oil of plant origin and resin of petroleum origin lies between 0.3 and 2.

29. The clear synthetic binder according to claim 19, wherein the oil of plant origin is chosen from among canola, sunflower, soybean, flax, olive, palm, castor, wood, corn, pumpkin seed, grape seed, jojoba, sesame, walnut, hazelnut, almond, shea, macadamia, cotton, alfalfa, rye, safflower, groundnut, coconut and copra oils, and mixtures thereof.

30. The clear synthetic binder according to claim 19, wherein the resin is chosen from among resins of hydrocarbon petroleum origin derived from the copolymerisation of aromatic, aliphatic, cyclopentadiene petroleum fractions, taken alone or in a mixture, derived from the copolymerisation of aromatic petroleum fractions.

31. The clear synthetic binder according to claim 30, wherein the polymer is chosen from among the copolymers of styrene and butadiene, the copolymers of styrene and isoprene, the ethylene/propene/diene terpolymers, polychloroprenes, the copolymers of ethylene and vinyl acetate, the copolymers of ethylene and methyl acrylate, the copolymers of ethylene and butyl acrylate, the ethylene/methyl acrylate/glycidyl methacrylate terpolymers, the ethylene/butyl acrylate/maleic anhydride terpolymers, the atactic polypropylenes, taken alone or in mixtures.

32. The clear synthetic binder according to claim 19, wherein the oil of plant origin comprises 10 to 90 weight % of free fatty acids, relative to the weight of oil of plant origin.

33. The clear synthetic binder according to claim 32, wherein the oil of plant origin comprises 0.1 to 5 weight % of free fatty acids, relative to the weight of oil of plant origin.

34. A method for preparing a clear synthetic binder comprising at least one oil of plant origin, at least one resin of petroleum origin and at least one polymer, the quantity of oil of plant origin in the binder being equal to or more than 10 weight % and the quantity of polymer in the binder being equal to or less than 15 weight %, the method comprising the following steps:
(i) mixing and heating the oil of plant origin at a temperature of between 140° C. and 200° C.;
(ii) gradually adding the resin of petroleum origin, mixing and heating to a temperature of between 140° C. and 200° C.;
(iii) adding the polymer(s), mixing and heating to a temperature of between 140° C. and 200° C.; and
(iv) optionally adding an adhesion agent, mixing and heating to a temperature of between 140° C. and 200° C.

35. A mix comprising a clear synthetic binder according to claim 19, and aggregates, optionally fillers and optionally pigments.

36. The method for preparing a mix according to claim 32, comprising the mixing of the clear synthetic binder, with aggregates, optionally with fillers and optionally with pigments, wherein the coating temperature lies between 100° C. and 160° C.

37. An emulsion of clear synthetic binder comprising a clear synthetic binder according to claim 19, water and an emulsifying agent.

38. A method for preparing an emulsion of clear synthetic binder according to claim 37, comprising the dispersion of the synthetic binder, in an emulsifying solution.

39. A cold mix, obtained by mixing aggregates, optionally fillers, optionally pigments, with an emulsion of clear synthetic binder according to claim 37.

40. A use of a clear synthetic binder comprising at least one oil of plant origin, at least one resin of petroleum origin and at least one polymer, the quantity of oil of plant origin in the binder being equal to or more than 10 weight % and the quantity of polymer in the binder being equal to or less than 15 weight %, the use comprising a manufacture of coloured surfacing for roads, carriageways, pavements, street networks, urban landscaping, hard surfaces, waterproofing of buildings or structures, in particular for the manufacture in roadway applications of surfacing layers such as binder courses and/or wear courses.

41. The use of a clear synthetic binder according claim 21, for the manufacture of coloured surfacing for roads, carriageways, pavements, street networks, urban landscaping, hard surfaces, waterproofing of buildings or structures, in particular for the manufacture in roadway applications of surfacing layers such as binder courses and/or wear courses.

42. The use of a clear synthetic binder according claim 22, for the manufacture of coloured surfacing for roads, carriageways, pavements, street networks, urban landscaping, hard surfaces, waterproofing of buildings or structures, in particular for the manufacture in roadway applications of surfacing layers such as binder courses and/or wear courses.

43. The use of a clear synthetic binder according claim 29, for the manufacture of coloured surfacing for roads, carriageways, pavements, street networks, urban landscaping, hard surfaces, waterproofing of buildings or structures, in particular for the manufacture in roadway applications of surfacing layers such as binder courses and/or wear courses.

44. The use of a clear synthetic binder according claim 30, for the manufacture of coloured surfacing for roads, carriageways, pavements, street networks, urban landscaping, hard surfaces, waterproofing of buildings or structures, in particular for the manufacture in roadway applications of surfacing layers such as binder courses and/or wear courses.

45. The use of a clear synthetic binder according claim 31, for the manufacture of coloured surfacing for roads, carriageways, pavements, street networks, urban landscaping, hard surfaces, waterproofing of buildings or structures, in particular for the manufacture in roadway applications of surfacing layers such as binder courses and/or wear courses.
